(19) United States
(12) Patent Application Publication
(10) Pub. No.: US 2024/0013099 A1
(43) Pub. Date: Jan. 11, 2024

(54) FRAMEWORKS FOR TRAINING OF FEDERATED LEARNING MODELS

(71) Applicant: Intel Corporation, Santa Clara, CA (US)

(72) Inventors: Rohit Verma, Bengaluru (IN); Arun Raghunath, Portland, OR (US); Juan Pablo Munoz, Folsom, CA (US); Nilesh Kumar Jain, Portland, OR (US)

(21) Appl. No.: 18/471,128

(22) Filed: Sep. 20, 2023

(30) Foreign Application Priority Data
Apr. 21, 2023 (IN) 202341029060

(51) Int. Cl. G06N 20/00

(52) U.S. Cl. CPC G06N 20/00

(57) ABSTRACT

Methods, apparatus and articles of manufacture to implement frameworks for training of federated learning models are disclosed. Example apparatus disclosed herein are to cause transmission of a first query to a first worker node of a plurality of worker nodes, the first query based on constraints to train a machine learning model. Disclosed example apparatus are also to cause transmission of a second query to a second worker node of the plurality of worker nodes, the second query based on the constraints. Disclosed example apparatus are further to cause transmission of a third query to the first worker node based on comparison of a first score from the first worker node to a second score from the second worker node, the third query instructing the first worker node to train the machine learning model.

### RELATED APPLICATION(S)

This patent claims priority to Indian Patent Application No. 202341029060, filed on Apr. 21, 2023. Indian Patent Application No. 202341029060 is incorporated herein by reference in its entirety.

### FIELD OF THE DISCLOSURE

This disclosure relates generally to machine learning and, more particularly, to methods and apparatus for frameworks for training of federated learning models.

### BACKGROUND

Machine learning is a subfield of artificial intelligence. In machine learning, instead of providing explicit instructions, programmers supply data to a model in a process called training. Training allows a machine learning model to infer outputs that were previously unknown to the model.

Training data is supplied to the machine learning model to adapt, test, and validate the model. Some models are trained via a process known as federated learning. Federated learning is a type of machine learning in which training data stays on the device where it was collected. In federated learning, a model may be sent to multiple worker nodes, with the model trained locally at each worker node. The local training results may be aggregated at a centralized node. Federated learning can allow for more efficient training than traditional, centralized training techniques.

### BRIEF DESCRIPTION OF THE DRAWINGS

FIG. 1 is a block diagram of an example environment in which an example system operates to perform federated learning techniques as described herein.

FIG. 2 is a block diagram of an example implementation of the aggregator circuitry and worker circuitry of FIG. 1.

FIGS. 3A-B illustrate a flowchart representative of example machine readable instructions and/or example operations that may be executed, instantiated, and/or performed by example programmable circuitry to implement the aggregator circuitry and/or the worker circuitry of FIG. 2.

FIG. 4 is a flowchart representative of example machine readable instructions and/or example operations that may be executed, instantiated, and/or performed by example programmable circuitry to implement the aggregator circuitry and/or the worker circuitry of FIG. 2.

FIG. 5 illustrates examples of queries sent between the example aggregator circuitry of FIG. 2 and the example worker circuitry of FIG. 2.

FIG. 6 illustrates further examples of queries that may be sent between the example aggregator circuitry of FIG. 2 and the example worker circuitry of FIG. 2.

FIG. 7 is a block diagram of an example processing platform including programmable circuitry structured to execute, instantiate, and/or perform the example machine readable instructions and/or perform the example operations of FIGS. 3A-B and/or 4 to implement the aggregator circuitry 102 and/or the worker circuitry 104 of FIG. 2.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIGS. 3A-B and/or 4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, a machine learning model(s) may be trained with data to recognize patterns and/or associations and follow such patterns and/or associations when processing input data such that other input(s) result in output(s) consistent with the recognized patterns and/or associations.

In general, implementing an ML/AI system involves two phases, a learning/training phase and an inference phase. In the learning/training phase, a compute unit uses a training algorithm to train the machine learning model(s) to operate in accordance with patterns and/or associations based on, for example, training data. In general, the machine learning model(s) include(s) internal parameters (e.g., configuration register data) that guide how input data is transformed into output data, such as through a series of nodes and connections within the machine learning model(s) to transform input data into output data. Additionally, hyperparameters are used as part of the training process to control how the learning is performed (e.g., a learning rate, a number of layers to be used in the machine learning model, etc.). Hyperparameters include training parameters that are determined prior to initiating the training process.

As used herein, data is information in any form that may be ingested, processed, interpreted and/or otherwise manipulated by processor circuitry to produce a result. The produced result may itself be data. As used herein, a model is a set of instructions and/or data that may be ingested, processed, interpreted and/or otherwise manipulated by processor circuitry to produce a result. A model may be operated using input data to produce output data in accordance with one or more relationships reflected in the model. The model may be based on training data. As used herein, a threshold is expressed as data, such as a numerical value represented in any form, a text string, etc., that may be used by processor circuitry as a reference for a comparison operation.

In some types of machine learning training, a single model may be trained at a centralized location and/or on a single compute unit (e.g., at a central server). While some means of (e.g., single location) training may be straightforward to implement, centralized systems can have shortcomings in performance and privacy. A centralized, nonprivate system may be unacceptable for a customer that does not wish to share its data. To illustrate, a hospital may not be authorized to share patient data (e.g., or even metadata associated with the patient data (e.g., number of patient classes and their labels)). Therefore, the hospital may not be able to upload the patient data to a cloud resource provider for training.

Federated learning techniques can allow for differential privacy. Federated learning (FL) is a decentralized learning framework in which a central server (e.g., an aggregator) sends a global model to remote compute units with their own data sources (e.g., worker nodes). Thus, instead of requesting training data from one or more worker nodes, the worker nodes themselves train the global model using their respective local data. Then, each worker node (e.g., worker circuitry) can send back the local model weights to the central server (e.g., aggregator circuitry). The central server aggregates the weights, and the process is iteratively repeated over many rounds until the global model achieves a threshold accuracy.

Some techniques for FL involve writing custom scripts for each application, which may be difficult to generalize and scale. Disclosed examples create a scalable solution for federated learning training over large quantities of data that may be spread across multiple locations. The decentralized and iterative nature of FL poses several challenges, which are overcome by the techniques described herein.

A first challenge in federated learning is selection of the nodes to include in the training process. In some training scenarios, only a subset of worker nodes are needed to efficiently converge to an accurate model. A second challenge in FL is that a relevant subset of the overall data at each worker node is chosen to locally train the model.

A third challenge in FL is data bias. Data bias in FL can be problematic due to the distributed nature of FL data. Bias may occur in reporting (e.g., users may post negative reviews more often than positive reviews), automation (e.g., favoring automated labels to manual labels), dataset selection (e.g., the dataset does not reflect real world), and/or implicitly (e.g., personal assumptions affecting labels/results).

A fourth challenge in FL involves ensuring an appropriate amount of work (e.g., a fair amount of work) is provided to each worker node. To illustrate, fairness may not be met when a first worker training on a small portion of data has its parameters equally weighted to a second worker (e.g., second worker circuitry, second worker node) that trains on ten times the data.

A fifth challenge in FL arises when a chosen data subset is to be pre-processed into a form usable by a model. The steps included in pre-processing may differ between ML models, and may involve manual customization. A sixth problem in FL is that it can be difficult to understand and analyze a resultant global model generated via federated learning. A seventh challenge in FL is that the training process at worker nodes may involve execution of multiple processes. The multiple processes may include pre-processing of data, batch creation, training, and communication with server. For use cases where the raw data should be preserved, copies of the data are stored for utilization each process.

The above listed challenges in FL techniques are caused at least in part by aggregator circuitry that lacks access to data at the worker nodes. Consequently, FL is often performed manually by writing custom scripts. Such manual programming is time consuming and difficult to scale.

The steps of FL: worker node selection, filtering data used for model training, aggregation, etc., are often custom built for a given model and application. Further, data pre-processing steps may be custom built for a model, using multiple processes that makes inefficient use of compute resources and have substantial storage needs.

In view of the above challenges, some disclosed examples interoperate with a Visual Data Management System (VDMS), which offers a framework to manage visual data (e.g., images), store metadata associated with the visual data in a graph store, query for data and/or meta-data by specifying constraints, and perform visual processing steps (e.g., a pipeline) on query results. VDMS provides a javascript object notation (JSON) application programming interface (API) for a client application to specify queries and desired processing steps. While some examples disclosed herein are described in association with VDMS, the techniques described herein are interoperable with other frameworks. That is, examples disclosed herein can add capabilities to automate and scale the federated learning model training process using any suitable client-facing system.

Some disclosed examples include a hierarchical framework to enable automatic data filtering, effective node selection (e.g., selection based on resource availability), reduction in bias, improved fairness, efficient pre-processing of data, and aggregation of parameters. In some examples, aggregator circuitry exposes a query interface to receive training and/or other FL management instructions. For example, the aggregator circuitry may present an interface for a user to provide a query without specifying the steps involved to execute the query. Therefore, the iterative details of the federated learning process may be simplified for an end-user. Examples disclosed herein maintain data privacy by internally creating subqueries that are executed on remote worker nodes without sending sensitive data to a central location. Some examples disclosed herein utilize a hierarchical framework and present a query interface to enable a generalized approach to FL that is scalable (e.g., in data size and geographically) and applicable to many different model types.

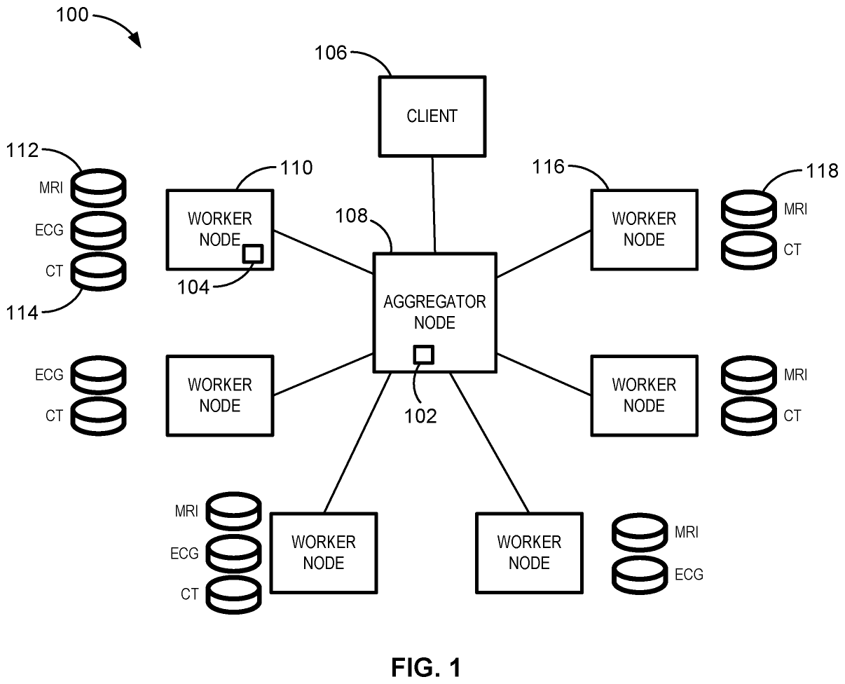

FIG. 1 is a block diagram of an example environment in which an example system 100 operates to perform federated learning techniques as described herein. The system 100 includes example aggregator circuitry 102, example worker circuitry 104, an example client device 106, an example aggregator node 108, an example first worker node 110, example first data 112, example second data 114, and an example second worker node 116.

The system 100 is an example hierarchy of visual data servers (e.g., VDMS servers) running on a central aggregator node 108 and running on multiple worker nodes (e.g., the first worker node 110, the second worker node 116). In the system 100, respective worker nodes are loaded with data and/or metadata for the respective node and do not have access to data of other worker nodes. For example, the first worker node 110 can access the first data (e.g., a first database) 112, but the first worker node 110 cannot access the third database 118. As an example, the system 100 is described in association with an ecosystem of medical institutions cooperating with each other for federated learning model training.

Many different types of machine learning models and/or machine learning architectures exist. In some examples, the aggregator circuitry 102 generates a machine learning model(s) as neural network model(s). In some examples, aggregator circuitry 102 may use a neural network model provided by the client 106 and/or any of the worker nodes (e.g., the first worker node 110, the second worker node 116, etc.) to execute an AI/ML workload. In some examples, the aggregator circuitry 102 may provide a neural network model to one or more worker nodes (e.g., for training via federated learning). In general, machine learning models/architectures that are suitable to use in the example approaches disclosed herein may include any type of neural network. However, other types of machine learning models could additionally or alternatively be used, such as supervised learning ANN models, clustering models, classification models, etc., and/or a combination thereof. Example clustering models may include k-means clustering, hierarchical clustering, mean shift clustering, density-based clustering, etc. Example classification models may include logistic regression, support-vector machine or network, Naive Bayes, etc.

Different types of training may be performed at each worker node (e.g., by example worker circuitry 104) based on the type of ML/AI model and/or an expected output. For example, the worker circuitry 104 and/or the aggregator circuitry 102 may invoke supervised training to use inputs and corresponding expected (e.g., labeled) outputs to select parameters (e.g., by iterating over combinations of select parameters) for machine learning model(s) that reduce model error. As used herein, “labeling” refers to identifying an expected output of the machine learning model (e.g., a classification, an expected output value, etc.). In some examples, the worker circuitry 104 and/or the aggregator circuitry 102 may invoke unsupervised training (e.g., used in deep learning, a subset of machine learning, etc.) that involves inferring patterns from inputs to select parameters for the machine learning model(s) (e.g., without the benefit of expected (e.g., labeled) outputs).

In some examples, the worker circuitry 104 trains a learning model(s) until the level of error stabilizes (e.g., stops becoming smaller). In some examples, the worker circuitry 104 may train the machine learning model(s) locally on the first worker node 110 and/or remotely at an external computing system communicatively coupled to the first worker node 110. In some examples, the worker circuitry 104 trains the machine learning model(s) using hyperparameters that control how the learning is performed (e.g., a learning rate, a number of layers to be used in the machine learning model, etc.). In some examples, worker circuitry 104 may use hyperparameters that control model performance and training speed such as the learning rate and regularization parameter(s). The worker circuitry 104 may select such hyperparameters by, for example, trial and error to reach an optimal model performance. In some examples, the aggregator circuitry 102 and/or the worker circuitry 104 may perform re-training. For example, the aggregator circuitry 102 and/or the worker circuitry 104 may execute such re-training in response to override(s) by the client 106, a receipt of new training data, etc. Once training is complete, the aggregator circuitry 102 may deploy the machine learning model(s) for use as an executable construct that processes an input and provide an output based on the network of nodes and connections defined in the machine learning model(s).

In some examples, output of the deployed one(s) of the machine learning model(s) may be captured and provided as feedback. By analyzing feedback, an accuracy of the deployed one(s) of the machine learning model(s) can be determined. If the feedback indicates that the accuracy of the deployed model is less than a threshold or other criterion, training of an updated model can be triggered using the feedback and an updated training data set, hyperparameters, etc., to generate an updated, deployed model.

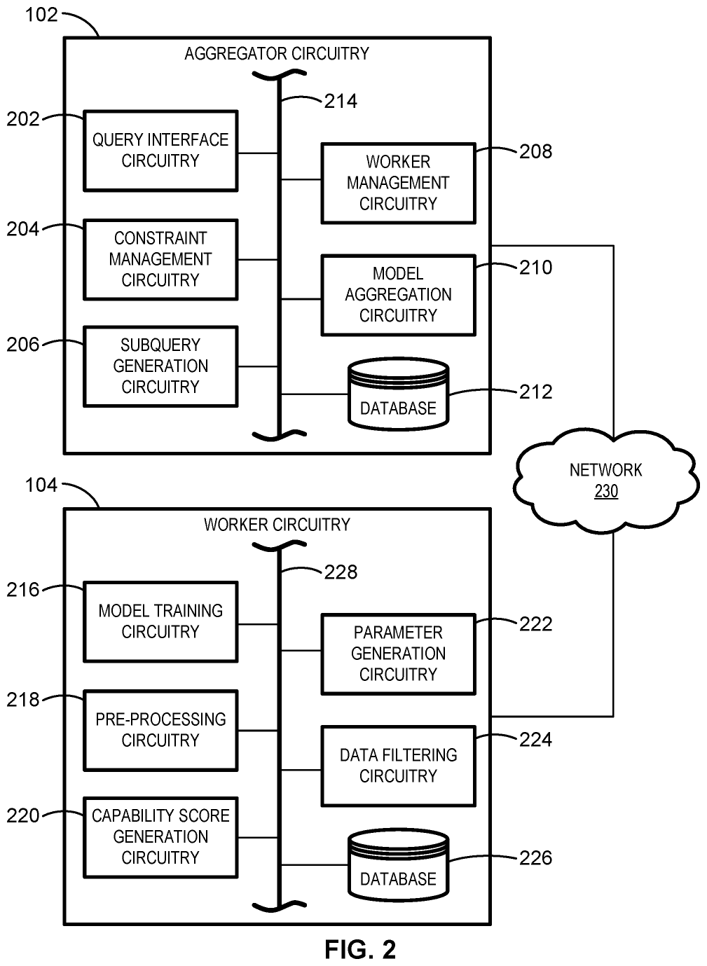

FIG. 2 is a block diagram of an example implementation of the aggregator circuitry 102 and/or the worker circuitry 104 of FIG. 1 to perform visual data management framework for training of federated learning models. The aggregator circuitry 102 and/or the worker circuitry 104 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the aggregator circuitry 102 and/or the worker circuitry 104 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example aggregator circuitry 102 includes example query interface circuitry 202, example constraint management circuitry 204, example subquery generation circuitry 206, example worker management circuitry 208, example model aggregation circuitry 210, and an example database 212. Furthermore the aggregator circuitry 102 may be communicatively coupled to worker circuitry 104 via a network 230 (e.g., the Internet).

The example worker circuitry 104 includes example model training circuitry 216, example pre-processing circuitry 218, example capability score generation circuitry 220, example parameter generation circuitry 222, example data filtering circuitry 224, and the example database 226. Any of the example worker circuitry 104 including example model training circuitry 216, example pre-processing circuitry 218, example capability score generation circuitry 220, example parameter generation circuitry 222, example data filtering circuitry 224, and the example database 226 may be communicatively coupled via a bus 214. Furthermore the worker circuitry 104 may be communicatively coupled to the aggregator circuitry 102 via the network 230.

The aggregator circuitry 102 provides user defined functions (UDFs) to the worker circuitry 104. In some examples, the aggregator circuitry 102 interoperates with built-in operations in a visual processing pipeline of an existing data management system (e.g., VDMS). Thus, the aggregator circuitry 102 can extend VDMS to enable execution of user specified functions in a machine learning processing pipeline. In some examples, the aggregator circuitry 102 and/or the worker circuitry 104 includes API extensions to specify a user function, include the user function in the processing pipeline, an implement framework support to invoke the function with the pipeline data being processed as input. Furthermore, the aggregator circuitry 102 may return a function output to a next operation in the processing pipeline. In some examples, the UDF invocation may occur in a separate process context. One example of a UDF may be within a web server, wherein the VDMS extension communicates with the UDF over hypertext transfer protocol (HTTP). Another example may be a container with an inter-process communication mechanism (e.g., shared memory, message queue, etc.) to transfer input/output data.

In some examples the aggregator circuitry 102 and/or the worker circuitry 104 provides extensibility to enable invocation of a UDF at a remote location (e.g., via a UDF API). The UDF API may add a remote URL, along with framework support for input/output parameter passing to/from the UDF executed remotely (e.g., over HTTP, over Non-Volatile Memory Express (NVMe) over-fabrics to enable execution of UDF at the block layer in a file system on a remote server). In some examples, the aggregator circuitry 102 and/or the worker circuitry 104 interoperate with an orchestration layer that spawns UDFs (e.g., local or remote). For example, an orchestrator may map function invocations to appropriate locations (e.g., based on resource availability and other factors).

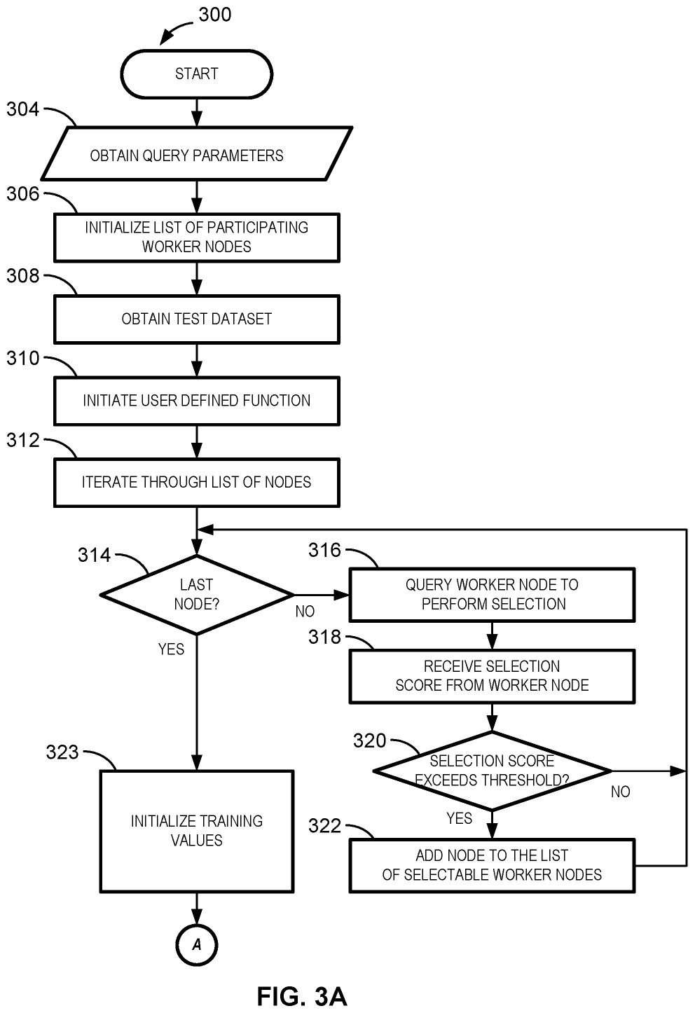

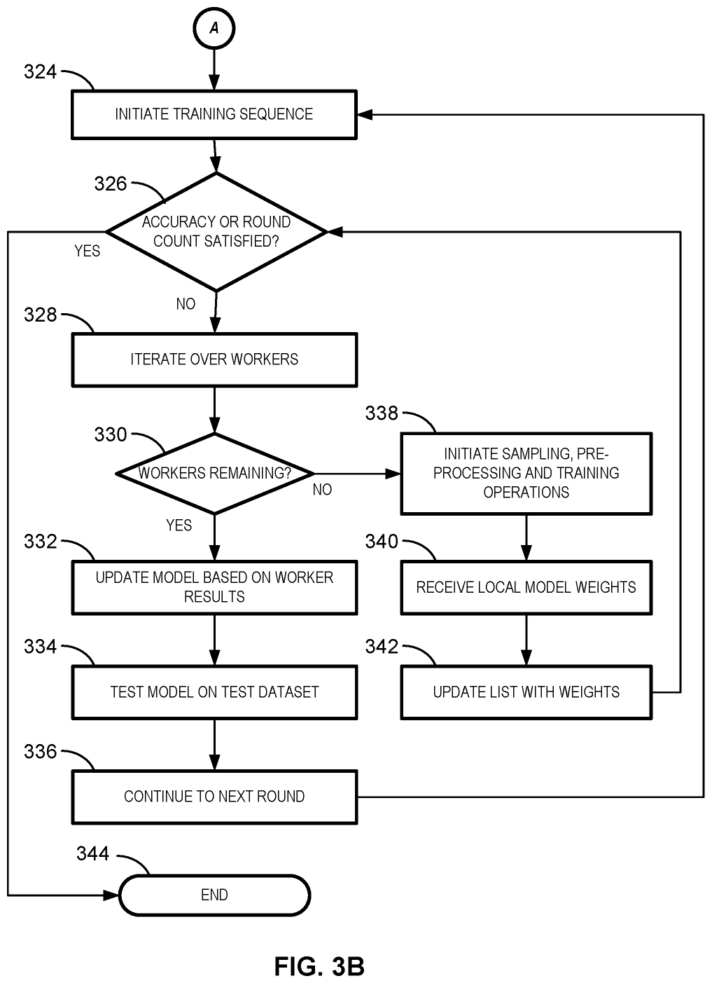

In some examples, the aggregator circuitry 102 is instantiated by programmable circuitry executing aggregator circuitry instructions and/or configured to perform operations such as those represented by the flowchart(s) of FIGS. 3A-B and/or 4.

The aggregator circuitry 102 includes the query interface circuitry 202. For example, the query interface circuitry 202 may receive input from a user that wants to train a neural network. The query interface circuitry 202 (e.g., and/or any other programmatic entity) may obtain a request from a user (e.g., “here are my constraints”, “here is my model”) and initiate the process of federated neural network training. The query interface circuitry 202 can obtain a query, analyze the query, provide the query to the constraint management circuitry 204 and/or the subquery generation circuitry 206, etc. In some examples, the constraints may include at least one of a target classification accuracy, a training round limit, or a list of worker nodes. For example, a query may specify an accuracy of 94%, a training round limit of 100, and a list of 10 worker nodes (e.g., a list of IP addresses).

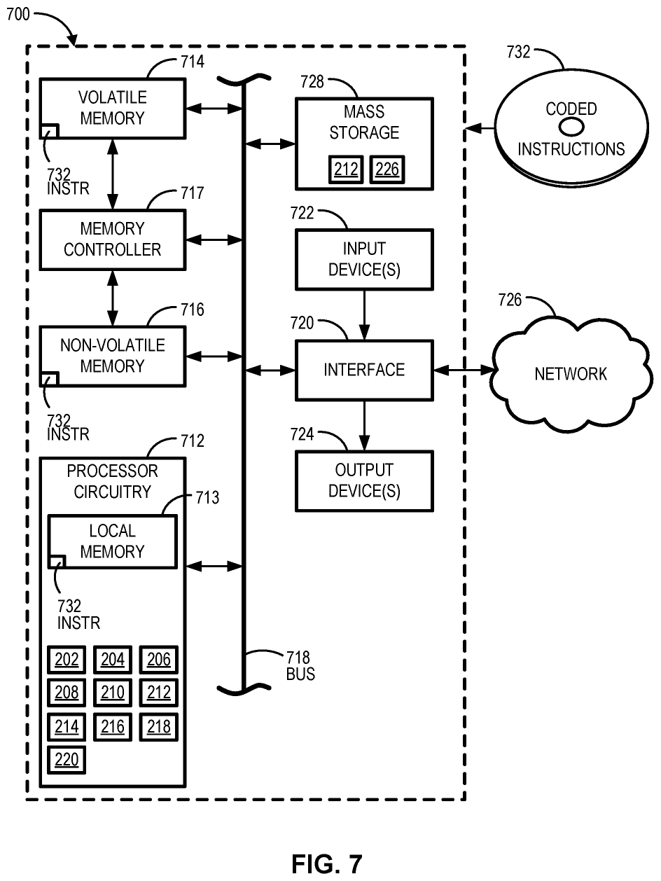

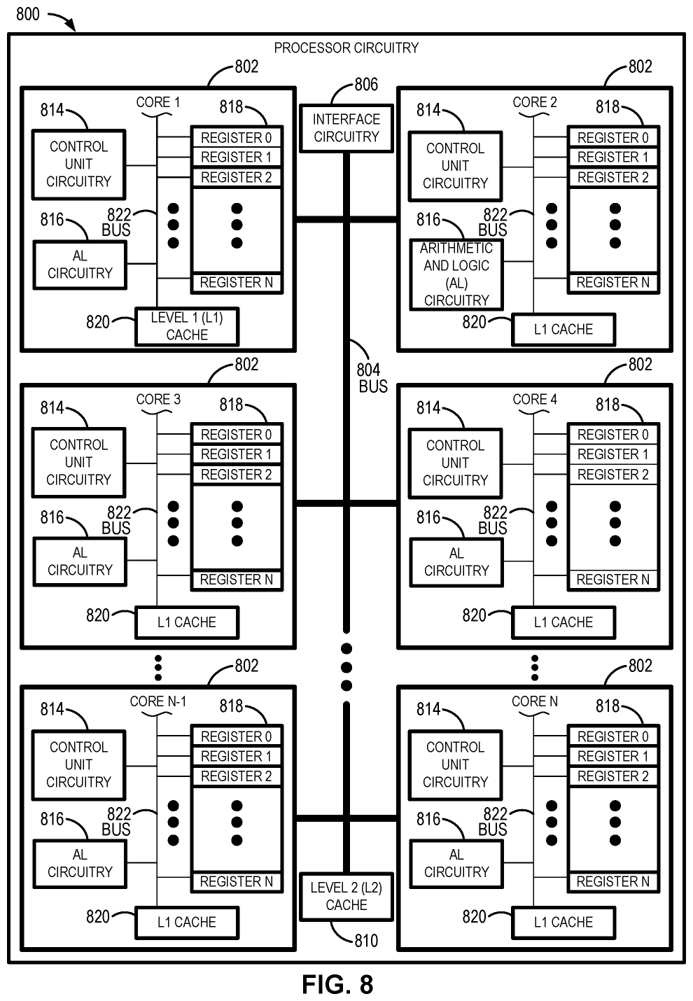

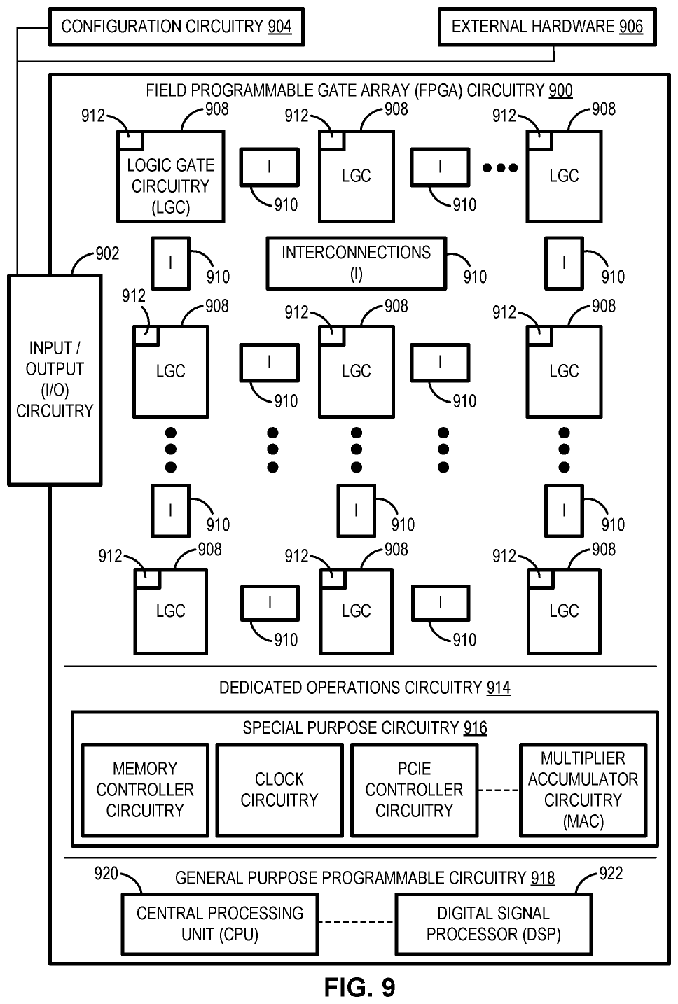

In some examples, the aggregator circuitry 102 and/or the worker circuitry 104 includes means for obtaining and processing a query for training a federated learning model. For example, the means for obtaining and processing a query for training a federated learning model may be implemented by the query interface circuitry 202. In some examples, the query interface circuitry 202 may be instantiated by programmable circuitry such as the example programmable circuitry 712 of FIG. 7. For instance, the query interface circuitry 202 may be instantiated by the example microprocessor 800 of FIG. 8 executing machine executable instructions such as those implemented by at least blocks 302, 304 of FIG. 3A. In some examples, query interface circuitry 202 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the query interface circuitry 202 may be instantiated by any other combination of hardware, software, and/or firmware. For example, the query interface circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example aggregator circuitry 102 includes the example constraint management circuitry 204. In some examples, a client wanting to perform federated model training provides functions for node selection, the actual model to train, training parameters (e.g., number of rounds, expected accuracy, batch size, training epochs, and an aggregation algorithm), etc. As the constraint management circuitry 204 can receive one or more parameters and/or constraints for entry into the system, the aggregator circuitry 102 can more flexibly perform training. For example, a higher learning rate can result in faster convergence, and a higher number of rounds can result in a more accurate model. Various aggregation methods can help determine how the aggregator circuitry 102 can combine model parameters and/or model updates from the one or more instances of the worker circuitry 104 performing federated learning. A user can also determine the structure of the model, the types of layers used, etc. Additional constraints are also capable of being received and/or managed by the constraint management circuitry 204.

In some examples, the aggregator circuitry 102 and/or the worker circuitry 104 includes means for managing constraints associated with a query for a federated learning model. For example, the means for managing may be implemented by constraint management circuitry 204. In some examples, the constraint management circuitry 204 may be instantiated by programmable circuitry such as the example programmable circuitry 712 of FIG. 7. For instance, the constraint management circuitry 204 may be instantiated by the example microprocessor 800 of FIG. 8 executing machine executable instructions such as those implemented by at least blocks 304, 306, 308 of FIG. 3. In some examples, constraint management circuitry 204 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the constraint management circuitry 204 may be instantiated by any other combination of hardware, software, and/or firmware. For example, the constraint management circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example aggregator circuitry 102 includes the example subquery generation circuitry 206. In examples described herein, a subquery is a query that is generated to be communicated to an instance of the worker circuitry 104. For example, the aggregator circuitry 102 may receive a first query from a user that includes constraints for training a neural network in a federated learning system. The aggregator circuitry 102 may then generate one or more subqueries (e.g., second queries) to aggregate data from multiple instances of the worker circuitry 104. The one or more subqueries facilitate training the global model at each of the instances of the worker circuitry 104 from individual parties without requiring them to share their training data.

The subquery generation circuitry 206 may automatically generate a subquery and then provide the subquery to the worker management circuitry 208. The subquery may be generated based on any suitable transformation such as a mapping of constraints between the aggregator circuitry 102 and the worker circuitry 104, adding or removing constraints, modifying a query for compatibility with model training circuitry 216 of a worker circuitry 104, etc. In some examples, the worker management circuitry 208 assigns a first access policy to first data stored by the first node; and assign a second access policy to second data stored by the second worker node, the first access policy to prohibit the second worker node from access to the first data. For example, the worker management circuitry 208 may assign a first access policy for a first worker node that prohibits a second worker node (e.g., storing CT scan data) from accessing data of the first worker node (e.g., MRI data).

In some examples, the aggregator circuitry 102 and/or the worker circuitry 104 includes means for generating a subquery from a query for training of a federated learning model. For example, the means for generating may be implemented by subquery generation circuitry 206. In some examples, the subquery generation circuitry 206 may be instantiated by programmable circuitry such as the example programmable circuitry 712 of FIG. 7. For instance, the subquery generation circuitry 206 may be instantiated by the example microprocessor 800 of FIG. 8 executing machine executable instructions such as those implemented by at least blocks 310, 312, 316 of FIG. 3. In some examples, subquery generation circuitry 206 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the subquery generation circuitry 206 may be instantiated by any other combination of hardware, software, and/or firmware. For example, the subquery generation circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example aggregator circuitry 102 includes the example worker management circuitry 208. The worker management circuitry manages worker nodes (e.g., instances of the worker circuitry 104) and can provide constraints to the worker nodes. In general, the worker management circuitry 208 can assign tasks to worker nodes and then subsequently collect updates that are generated by the worker nodes (e.g., updated model parameters from parameter generation circuitry 222). The worker management circuitry 208 may assign tasks to worker circuitry 104 such as training a model or a part of a model.

In some examples, the worker management circuitry 208 selects a worker node to train a portion of a machine learning model. (e.g., to promote fairness). For example, the worker management circuitry 208 may execute a selection function that selects an instance of the worker circuitry 104 for execution of a training workload. Furthermore, the worker management circuitry 208 may provide constraints from the constraint management circuitry 204 to select a subset of data that is stored and/or maintained by the selected worker node for training of the model (e.g., by model training circuitry 216).

In some examples, the aggregator circuitry 102 and/or the worker circuitry 104 includes means for managing one or more worker nodes associated with a federated learning system. For example, the means for managing may be implemented by worker management circuitry 208. In some examples, the worker management circuitry 208 may be instantiated by programmable circuitry such as the example programmable circuitry 712 of FIG. 7. For instance, the worker management circuitry 208 may be instantiated by the example microprocessor 800 of FIG. 8 executing machine executable instructions such as those implemented by at least blocks 312, 320 of FIG. 3. In some examples, worker management circuitry 208 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the worker management circuitry 208 may be instantiated by any other combination of hardware, software, and/or firmware. For example, the worker management circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example aggregator circuitry 102 includes the model aggregation circuitry 210. The example model aggregation circuitry 210 can aggregate model parameters based on an aggregation algorithm. For example, the model aggregation circuitry 210 may perform aggregation based on federated averaging, in which parameters for a distributed model are obtained from two or more worker nodes including the worker circuitry 104. Then, the results are averaged. By averaging the results, an updated version of the model can be created by the model aggregation circuitry 210. The updated model can then be transmitted by the model aggregation circuitry 210 back to the instances of the worker circuitry 104 for further training. Other methods such as weighted averaging, in which different weights are assigned to various parameters based on worker selection and/or worker characteristics, may also be used by the model aggregation circuitry 210.

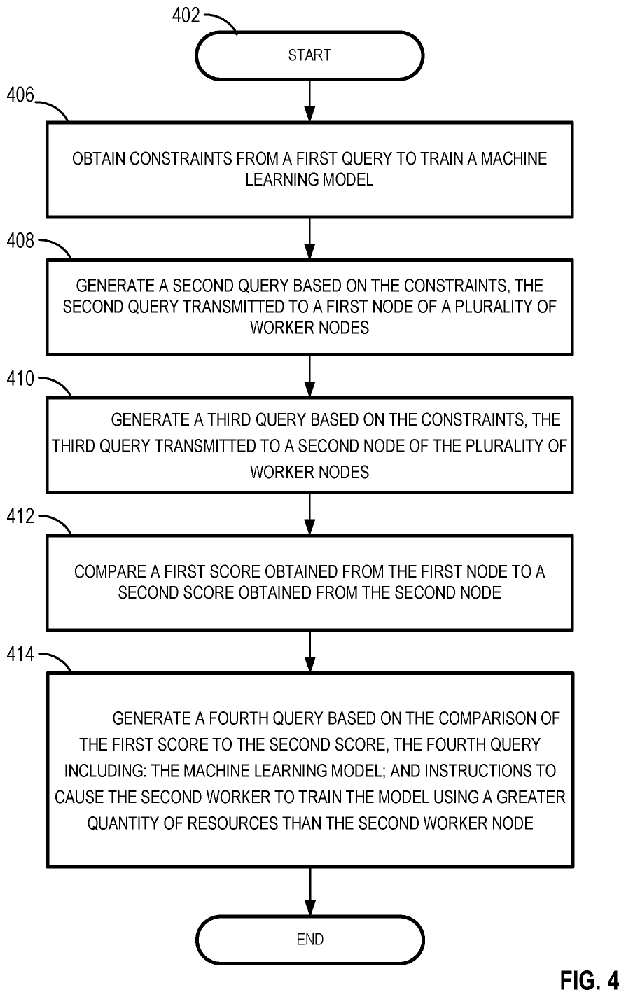

In some examples, the aggregator circuitry 102 and/or the worker circuitry 104 includes means for aggregating parameters of a federated machine learning model. For example, the means for aggregating may be implemented by model aggregation circuitry 210. In some examples, the model aggregation circuitry 210 may be instantiated by programmable circuitry such as the example programmable circuitry 712 of FIG. 7. For instance, the model aggregation circuitry 210 may be instantiated by the example microprocessor 800 of FIG. 8 executing machine executable instructions such as those implemented by at least blocks 410 of FIG. 4. In some examples, model aggregation circuitry 210 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the model aggregation circuitry 210 may be instantiated by any other combination of hardware, software, and/or firmware. For example, the model aggregation circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example worker circuitry 104 includes the model training circuitry 216. The model training circuitry 216 receives constraints from the constraint management circuitry 204 and/or the model aggregation circuitry 210. The model training circuitry 216 may also receive a machine learning model from the aggregator circuitry 102. The model training circuitry 216 may then train the model received from the aggregator circuitry 102 using the data that is available to the worker circuitry 104. For example, the worker circuitry 104 may retrieve data from the database 226 for training. The model training circuitry 216 may train the model using any of the training techniques described herein. For example, the model training circuitry 216 may train a model provided by the aggregator circuitry 102 using stochastic gradient descent, generating parameter values that can be provided to the parameter generation circuitry 222 for transmission back to the aggregator circuitry 102.

In some examples, the aggregator circuitry 102 and/or the worker circuitry 104 includes means for training a machine learning model. For example, the means for training may be implemented by model training circuitry 216. In some examples, the model training circuitry 216 may be instantiated by programmable circuitry such as the example programmable circuitry 712 of FIG. 7. For instance, the model training circuitry 216 may be instantiated by the example microprocessor 800 of FIG. 8 executing machine executable instructions such as those implemented by at least blocks 416, 418, 420 of FIG. 4. In some examples, model training circuitry 216 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the model training circuitry 216 may be instantiated by any other combination of hardware, software, and/or firmware. For example, the model training circuitry 216 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example worker circuitry 104 includes the pre-processing circuitry 218. The pre-processing circuitry 218 can prepare data (e.g., training data stored locally in the database 226) for training by the model training circuitry 216. Pre-processing techniques such as data selection, data normalization, feature selection, etc., can help to improve model accuracy, adapt the local data to the model, reduce noise in the dataset, etc.

In some examples, the aggregator circuitry 102 and/or the worker circuitry 104 includes means for pre-processing a portion of data that is not shared with an aggregator node, the pre-processing of the data to occur prior to training of a federated learning model with the data. For example, the means for pre-processing may be implemented by pre-processing circuitry 218. In some examples, the pre-processing circuitry 218 may be instantiated by programmable circuitry such as the example programmable circuitry 712 of FIG. 7. For instance, the pre-processing circuitry 218 may be instantiated by the example microprocessor 800 of FIG. 8 executing machine executable instructions such as those implemented by at least blocks 416 of FIG. 4. In some examples, pre-processing circuitry 218 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the pre-processing circuitry 218 may be instantiated by any other combination of hardware, software, and/or firmware. For example, the pre-processing circuitry 218 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example worker circuitry 104 includes the capability score generation circuitry 220. The capability score generation circuitry 220 can generate a worker score that indicates how effectively the worker circuitry 104 can participate in the federated learning initiated by the aggregator circuitry 102. For example, the capability score generation circuitry 220 may determine a capability based on access to computational resources. In such an example, the capability score generation circuitry 220 may provide a greater capability score when the worker circuitry 104 has access to more and/or different computational resources than another worker circuitry. For example, a first instance of the worker circuitry 104 may be coupled to a CPU operating at 700 megahertz (MHz), while a second instance of the worker circuitry 104 may be coupled to a CPU operating at 900 (MHz). In such an instance, the first instance of the worker circuitry 104 may generate (and/or be assigned) a capability score of 100, while the second instance of the worker circuitry 104 may generate (and/or be assigned) a capability score of 200. In some examples, a first instance of the worker circuitry 104 may execute on CPUs exclusively, while a second instance of the worker circuitry 104 may execute on a combination of CPUs, GPUs, and/or accelerator circuitry. In such an example, the second instance of the worker circuitry may generate (e.g., provide, be assigned, etc.) a greater capability score (e.g., 0.3) than the capability score (e.g., 0.25) assigned to the first instance of the worker circuitry. For example, a capability score may be increased by one unit for each processing core, and the score multiplied by an average clock speed of the processing cores. In some examples, aggregator circuitry may store benchmark values for use in generation of a capability score in a database for later retrieval.

The capability score generation circuitry 220 may also generate the capability score based on the amount and/or quality of data the worker circuitry 104 has access to. For example, if the worker circuitry 104 is provided a machine learning model to be used to identify a specific medical condition (e.g., a broken hand), the capability score generation circuitry 220 may assign a greater capability score if it identifies the worker circuitry 104 has access to training data that is associated with the condition (e.g., X-rays of a broken hand). For example, the capability score may be increased by one unit for each megabyte (MB) of relevant data.

In some examples, the aggregator circuitry 102 and/or the worker circuitry 104 includes means for generating a capability score, the capability score indicative of a capability of a worker node to execute a federated training workload. For example, the means for generating may be implemented by capability score generation circuitry 220. In some examples, the capability score generation circuitry 220 may be instantiated by programmable circuitry such as the example programmable circuitry 712 of FIG. 7. For instance, the capability score generation circuitry 220 may be instantiated by the example microprocessor 800 of FIG. 8 executing machine executable instructions such as those implemented by at least blocks 318 of FIG. 3. In some examples, capability score generation circuitry 220 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the capability score generation circuitry 220 may be instantiated by any other combination of hardware, software, and/or firmware. For example, the capability score generation circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example worker circuitry 104 includes the parameter generation circuitry 222. The parameter generation circuitry 222 generates parameters that can be used in training a machine learning model. For example, the parameter generation circuitry 222 can generate a model weight that will be provided to the worker management circuitry 208. In some examples, the parameter generation circuitry 222 provides a parameter to the aggregator circuitry 102 and subsequently performs a second round of local model training. When the parameter generation circuitry 222 iteratively generates new rounds of parameters (e.g., using updated models provided by the aggregator circuitry 102 on each iteration) the parameters can begin to converge. Other parameters such as hyperparameters, gradients, accuracy metrics, etc., may also be generated by the parameter generation circuitry 222.

In some examples, the aggregator circuitry 102 and/or the worker circuitry 104 includes means for generating a parameter to transmit to an aggregator node to update a model. For example, the means for generating a parameter may be implemented by parameter generation circuitry 222. In some examples, the parameter generation circuitry 222 may be instantiated by programmable circuitry such as the example programmable circuitry 712 of FIG. 7. For instance, the parameter generation circuitry 222 may be instantiated by the example microprocessor 800 of FIG. 8 executing machine executable instructions such as those implemented by at least blocks 410 of FIG. 4. In some examples, parameter generation circuitry 222 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the parameter generation circuitry 222 may be instantiated by any other combination of hardware, software, and/or firmware. For example, the parameter generation circuitry 222 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example worker circuitry 104 includes the data filtering circuitry 224. The data filtering circuitry 224 may select a subset (e.g., a portion) of a data set and use that subset for viewing or analysis. For example, health data may be filtered by age, with the data filtering circuitry 224 selecting MRI images of patients from ages 18-65 for training.

In some examples, the aggregator circuitry 102 and/or the worker circuitry 104 includes means for filtering data. For example, the means for filtering may be implemented by data filtering circuitry 224. In some examples, the data filtering circuitry 224 may be instantiated by programmable circuitry such as the example programmable circuitry 712 of FIG. 7. For instance, the data filtering circuitry 224 may be instantiated by the example microprocessor 800 of FIG. 8 executing machine executable instructions such as those implemented by at least blocks 410 and 416 of FIG. 4. In some examples, data filtering circuitry 224 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the data filtering circuitry 224 may be instantiated by any other combination of hardware, software, and/or firmware. For example, the data filtering circuitry 224 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example aggregator circuitry 102 includes the database 212. The database 212 may store machine learning parameters, machine learning models, training data, validation metrics, etc., as described herein. To aid in analyzing the final global model generated, the example database 212 and/or the example database 226 may store log files of the locally trained model parameters received from workers for each training round. This information can be used to trace back to the parameters received from each worker that led to the final global model. At worker node(s), support may be added to log the data items selected per batch for each epoch. This enables analysis by the owner of the data at a remote node to trace through the data items selected which led to the local model parameters for a given training round. With the information at these two levels, logs at the aggregator circuitry 102 can be used to determine which local model parameters led to the final global model values. At this point, the owner of the data at the remote node can be requested to analyze the data at that node using the batch logs per epoch. Together, these two levels of information can be used to analyze and debug global models generated automatically.

While an example manner of implementing the aggregator circuitry 102 and/or the worker circuitry 104 of FIG. 1 is illustrated in FIG. 2, one or more of the elements, processes, and/or devices illustrated in FIG. 2 may be combined, divided, re-arranged, omitted, eliminated, and/or implemented in any other way. Further, the example constraint management circuitry 204, the example subquery generation circuitry 206, the example worker management circuitry 208, the example model aggregation circuitry 210, the example model training circuitry 216, the example pre-processing circuitry 218, the example capability score generation circuitry 220, the example parameter generation circuitry 222, the example data filtering circuitry 224, the example query interface circuitry 202, and/or, more generally, the example aggregator circuitry 102 and/or the worker circuitry 104 of FIG. 2, may be implemented by hardware alone or by hardware in combination with software and/or firmware. Thus, for example, any of the example constraint management circuitry 204, the example subquery generation circuitry 206, the example worker management circuitry 208, the example model aggregation circuitry 210, the example model training circuitry 216, the example pre-processing circuitry 218, the example capability score generation circuitry 220, the example parameter generation circuitry 222, the example data filtering circuitry 224, the example query interface circuitry 202, and/or, more generally the example aggregator circuitry 102 and/or the worker circuitry 104, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example aggregator circuitry 102 and/or the worker circuitry 104 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the aggregator circuitry 102 and/or the worker circuitry 104 of FIG. 2 and/or representative of example operations which may be performed by programmable circuitry to implement and/or instantiate the aggregator circuitry 102 and/or the worker circuitry 104 of FIG. 2, are shown in FIGS. 3A-B and/or 4. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3A-B and/or 4, many other methods of implementing the example aggregator circuitry 102 and/or the worker circuitry 104 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 3A-B and/or 4 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

FIGS. 3A-B illustrate a flowchart representative of example machine readable instructions and/or example operations 300 that may be executed, instantiated, and/or performed by programmable circuitry to perform federated learning. The instructions 300 of FIG. 3 start at block 304 at which the query interface circuitry 202 and/or the constraint management circuitry 204 obtain query parameters such as a desired accuracy, a maximum number of rounds for training, a list of participating worker nodes to use for the training, etc. The list of participating worker nodes and/or any of the other query parameters can be specified as part of the client query itself or provided as metadata into the aggregator circuitry 102.

At block 306 a list of participating worker nodes is set as empty. Then, at block 308, the example subquery generation circuitry 206 and/or worker management circuitry 208 obtains a test dataset from a database. At block 310, the model aggregation circuitry 210 initiates a federated learning user defined function (e.g., the UDF from which query parameters were obtained at block 304). Then, at block 312, the example worker management circuitry 208 loops over the list of participating worker nodes.

At block 314, the worker management circuitry 208 determines if the worker nodes in the list of participating worker nodes has been processed. If so, the instructions continue at block 323 at which training values are initialized by aggregator circuitry 102 for the worker circuitry 104. However, if at block 314 the worker management circuitry 208 determines that there are remaining participating worker nodes to be processed, the instructions continue at block 316 at which the subquery generation circuitry 206 and/or the worker management circuitry 208 queries an instance of the worker circuitry 104 at an unprocessed worker node for a selection score. At block 320, if the selection score is greater than a threshold value, then at block 322 the example worker management circuitry 208 adds that worker node (or the instance of the worker circuitry 104 at that worker node) to a list of selectable worker nodes. The instructions return to block 314.

Thus, the operations 302-320 illustrate one method in which aggregator circuitry 102 (e.g., a VDMS(A)) can select the workers to include in the training process. In some examples, the aggregator circuitry 102 automatically generates a new query using parameters from an original client query and received by the query interface circuitry 202. This query is sent to one or more instances of the worker circuitry 104 and one or more different worker nodes, requesting execution of a selection function (e.g., selector). The query interface circuitry 202 uses the aggregator query constraints to select the data subset within its node on which the selector UDF is run. The results are returned to aggregator circuitry 102, which uses the result from the different worker to select the worker nodes to use for training. In this fashion, an aggregator can automatically use query constraints to filter data fed to a UDF executed at the worker circuitry 104 without requiring the actual data to be transferred to it. The selection function can be user-defined and tailored to the specific model being trained. This UDF can include model relevant logic to determine data heterogeneity for example.

FIG. 3B is a continuation of the flowchart of FIG. 3B, representative of example machine readable instructions and/or example operations 300 that may be executed, instantiated, and/or performed by programmable circuitry to perform federated training of a machine learning model. The instructions of FIG. 3B start at block 324, at which the model aggregation circuitry 210 initiates a training sequence. At block 326, the example model training circuitry 216 determines if the model accuracy has satisfied a threshold value or if a threshold number of rounds have elapsed. If so, instructions end. However, if at block 326 the model training circuitry 216 determines that further training is to be performed, then control continues to block 406 at which the model training circuitry 328 loops over the list of worker nodes. If nodes remain, control continues to block 338 at which the worker management circuitry 208 sends a subquery generated by the subquery generation circuitry 206 to the worker circuitry 104 to perform sampling, pre-processing, and training operations. Then, at block 340, the parameter generation circuitry 222 provides the model aggregation circuitry 210 the local model weights and updates the weight. At block 342, the list of weights is updated with the local model weight by the model aggregation circuitry 210.

The instructions 332-336 instruct selected worker(s) to locally train a model using data present on that worker node. Some examples automatically generate a new query sent to the subset of worker nodes selected. This query again uses information from the original client query to specify the constraints to filter data and the model to train (e.g., a UDF executing on filtered data). In some examples, the query also includes the pre-processing steps to perform on the selected data. In some examples, the worker management circuitry 208 may send the same query to all the worker nodes. In some examples, the aggregator circuitry 102 may send specialized queries tailored to specific worker nodes based on their characteristics, such as resources, data size, network bandwidth, etc., accounting for fairness considerations.

When a worker (e.g., VDMS(W)) receives a query, the worker can filter the data using query constraints. However, in some examples, a model training run includes several epochs, wherein each epoch runs on a small sample (e.g., batch), from within the selected data. This is in contrast with other visual processing pipelines in which all the operations in the pipeline are run over a selected data item, and this is repeated for all selected items.

Some examples disclosed herein provide a group user operation that provides a group of selected data items to an operation (e.g., instead of a single item). To select a batch, the aggregator circuitry 102 may create a sampling group operation. The sampling operation receives a group of data items as input and returns a subset of the group as the current batch. One embodiment of a sampling algorithm could be to randomly pick a batch of the specified size from the input data set. The batch is then sent through the pre-processing pipeline, where each item in the batch is operated upon by every stage in the pipeline. Once the items in the batch are run through the pre-processing pipeline the model can be run on the pre-processed batch. In such an example, the training itself is a group operation (e.g., as it operates on multiple data items). In this fashion, one epoch of the training UDF is run over a sampled batch of data. The steps of sampling a batch, pre-processing each item in the batch, and running an epoch may be repeated for the specified number of epochs in the model. After all epochs are done, one training run of the model is complete. The generated model parameters from the training run on the local data is returned by the worker circuitry 104 as the response to the query from the aggregator circuitry 102.

The aggregator circuitry 102 (e.g., VDMS(A)) receives the locally trained model parameters as responses from the worker node it queries. Then, some examples aggregate the local model parameters to generate the global model parameters. Since the aggregation algorithm can be model specific, some examples use a UDF provided by a client for aggregation. This generates a global model.

In some examples, the global model is tested for accuracy (e.g., again using another UDF). If the desired accuracy is not achieved, another training run is initiated by VDMS(A). Queries are generated and sent to the workers where each query includes the current global model parameters. Each worker completes another training round in the same manner as described earlier. In some examples, a worker node may have the flexibility to use a local test dataset to choose to adopt the global weights or continue optimizing its local weights. When the global model meets the desired accuracy (e.g., or the specified number of training runs), its parameters are returned as the response for the original client query.

Thus, the operations 300 and 400 enable federated learning model training (e.g., by building on VDMS capabilities) based on data filtering via constraints and data transformation via an operation pipeline, along with the added capabilities of node selection, data sampling, group operations, aggregation, and accuracy checking. The UDF techniques disclosed in the operations 300 and 400 provide the flexibility to perform operations specific to the model and allow FL training to occur remotely while maintaining data privacy. Some examples enable FL training at scale while reducing manual intervention.

FIG. 4 is a flowchart representative of example machine readable instructions and/or example operations 402 that may be executed, instantiated, and/or performed by programmable circuitry to perform federated learning. The instructions 402 of FIG. 4 start at block 406, at which the constraint management circuitry 204 obtains constraints from a first query to train a machine learning model. At block 408 the example subquery generation circuitry 206 generates a second query based on the constraints, the second query transmitted to a first node of a plurality of worker nodes. At block 410 the subquery generation circuitry 206 generates a third query based on the constraints, the third query transmitted to a second node of the plurality of worker nodes. At block 412 the example worker management circuitry 208 and/or the example model aggregation circuitry 210 compares a first score obtained from the first node to a second score obtained from the second node. At block 414 the example subquery generation circuitry 206 generates a fourth query based on the comparison of the first score to the second score, the fourth query including: the machine learning model; and instructions to cause the second worker to train the model using a greater quantity of resources than the second worker node. The instructions end.

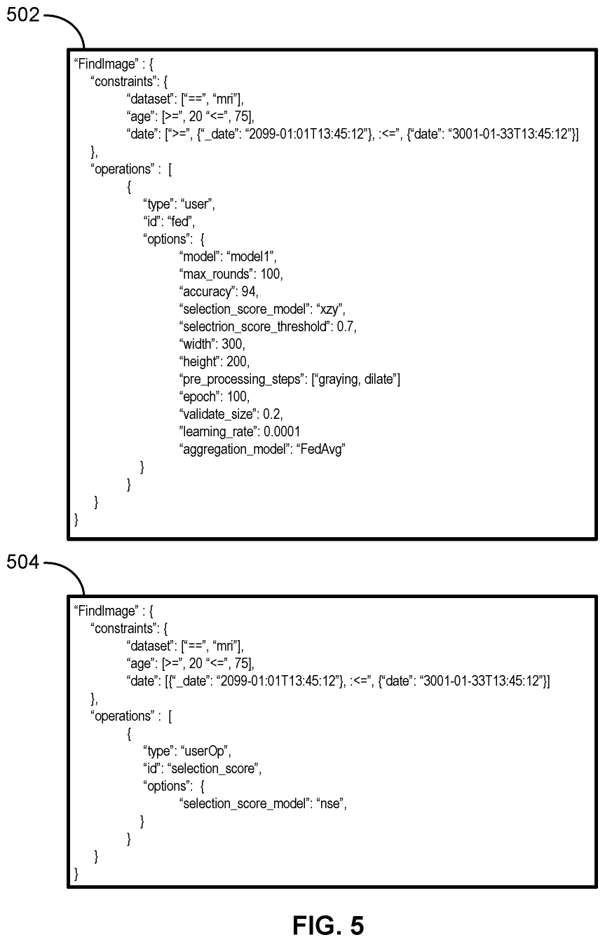

FIG. 5 is an example of queries 502 and 504 that may be transmitted between the example aggregator circuitry 102 and the example worker circuitry 104 of FIG. 2. Table 502 indicates a query sent to the aggregator circuitry 102 from a client. In the example of FIG. 5, each query is formatted in a javascript object notation (JSON) data storage format. For example, the first query 502 indicates a selection score model and a threshold can be identified by the constraint management circuitry 204 to manage a query sent to the workers. Some embodiments of query constraints might include class labels that partition the data at each worker node. Table 504 indicates a selection score generation subquery sent to connected nodes.

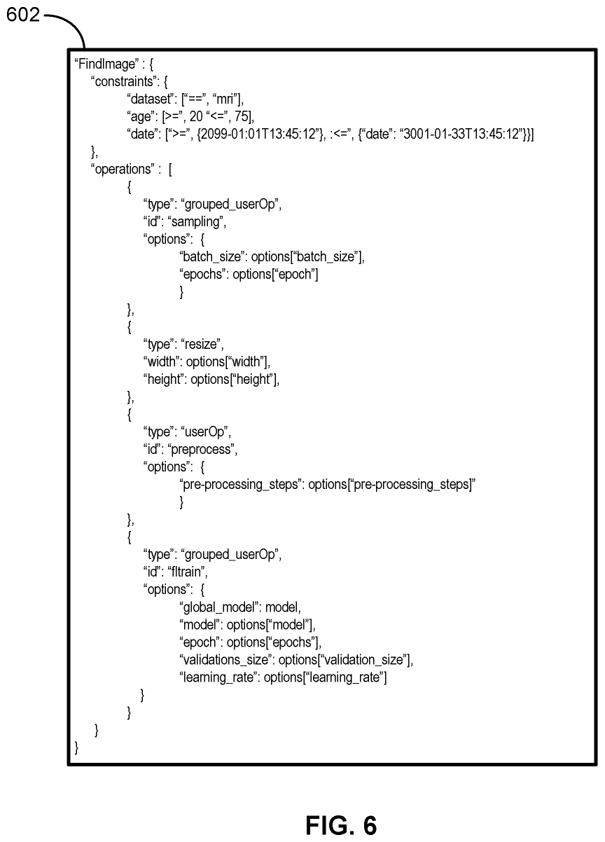

FIG. 6 is an example of another example subquery that may be sent between the example aggregator circuitry 102 of FIG. and the example worker circuitry 104 of FIG. 2. Thus, the Table 602 is an example of a training query that may be sent per worker based on its characteristics.

FIG. 7 is a block diagram of an example programmable circuitry platform 700 structured to execute and/or instantiate the example machine-readable instructions and/or the example operations of FIGS. 3A-B and/or 4 to implement the aggregator circuitry 102 and/or the worker circuitry 104 of FIG. 2. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the example constraint management circuitry 204, the example subquery generation circuitry 206, the example worker management circuitry 208, the example model aggregation circuitry 210, the example model training circuitry 216, the example pre-processing circuitry 218, the example capability score generation circuitry 220, the example parameter generation circuitry 222, the example data filtering circuitry 224, the example query interface circuitry 202, and/or, more generally, the aggregator circuitry 102 and/or the worker circuitry 104

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 3A-B and/or 4, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 3A-B and/or 4 to effectively instantiate the circuitry of FIG. 2 as logic circuits to perform operations corresponding to those machine readable instructions. In some such examples, the circuitry of FIG. 2 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 3A-B and/or 4.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMS s), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIGS. 3A-B and/or 4 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 3A-B and/or 4. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3A-B and/or 4. As such, the FPGA circuitry 900 may be configured and/or structured to effectively instantiate some or all of the operations/functions corresponding to the machine readable instructions of the flowchart(s) of FIGS. 3A-B and/or 4 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 3A-B and/or 4 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 3A-B and/or 4 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIGS. 3A-B and/or 4 to perform first operation(s)/function(s), the FPGA circuitry 900 of FIG. 9 may be configured and/or structured to perform second operation(s)/function(s) corresponding to a second portion of the machine readable instructions represented by the flowcharts of FIGS. 3A-B and/or 4, and/or an ASIC may be configured and/or structured to perform third operation(s)/function(s) corresponding to a third portion of the machine readable instructions represented by the flowcharts of FIGS. 3A-B and/or 4.

It should be understood that some or all of the circuitry of FIG. 2 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 2 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

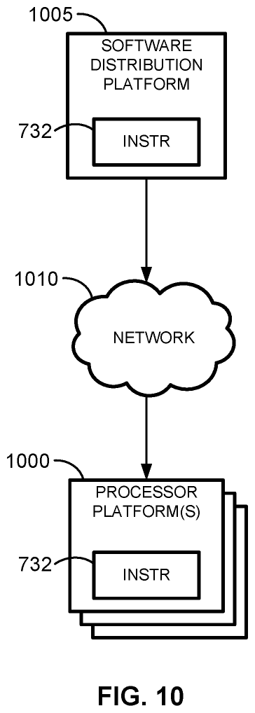

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud or edge service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 3A-B and/or 4, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIGS. 3A-B and/or 4, may be downloaded to the example programmable circuitry platform 700, which is to execute the machine readable instructions 732 to implement the aggregator circuitry 102 and/or the worker circuitry 104. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that train federated learning models. Disclosed systems, apparatus, articles of manufacture, and methods improve the efficiency of using a computing device by creating generalized framework for federated learning that is scalable and provides the following benefits: automation of data filtering, automation of worker node selection (e.g., enabling handling of heterogenous data), offering flexibility via user defined functions, automation of configuration of parameter aggregation methods, automation of data augmentation to tackle biases (e.g., class imbalance at a worker node), handling data bias, handling fairness and/or data volume skew (e.g., by weighted averaging at aggregator), providing privacy via subqueries and function remoting that execute in-situ at remote workers, providing a generalized API for specifying a visual processing pipeline as part of a query enabling efficient in-situ data pre-processing, and allowing audit trails for FL model debugging. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to implement frameworks for training of federated learning models are disclosed herein. Further examples and combinations thereof include the following.

Example 1 includes an apparatus comprising interface circuitry, one or more instructions, and programmable circuitry to utilize the one or more instructions to cause transmission of a first query to a first worker node of a plurality of worker nodes, the first query based on constraints to train a machine learning model, cause transmission of a second query to a second worker node of the plurality of worker nodes, the second query based on the constraints, and cause transmission of a third query to the first worker node based on comparison of a first score from the first worker node to a second score from the second worker node, the third query instructing the first worker node to train the machine learning model.

Example 2 includes the apparatus of example 1, wherein the third query specifies a first quantity of resources to be used by the first worker node to train the machine learning model, and the programmable circuitry is to cause transmission of a fourth query to the second worker node, the fourth query instructing the second worker node to train the machine learning model using a second quantity of resources less than the first quantity of resources to be used by the first worker node.

Example 3 includes the apparatus of example 2, wherein the programmable circuitry is to obtain first weights for the machine learning model from the first worker node, obtain second weights for the machine learning model from the second worker node, and update the machine learning model based on an aggregation of the first weights and the second weights.

Example 4 includes the apparatus of example 1, wherein the first score is based on a quantity of data stored by the first worker node that is associated with a category identified in the constraints.

Example 5 includes the apparatus of example 1, wherein the programmable circuitry is to assign a first access policy to first data stored by the first worker node, and assign a second access policy to second data stored by the second worker node, the first access policy to prohibit the second worker node from access to the first data.

Example 6 includes the apparatus of example 1, wherein the constraints include at least one of a target classification accuracy, a training round limit, or a list of worker nodes.

Example 7 includes the apparatus of example 1, wherein the programmable circuitry is to obtain the constraints via at least one of an application programming interface, a web server, or a container.

Example 8 includes a non-transitory computer readable storage medium comprising instructions to cause programmable circuitry to at least cause transmission of a first query to a first worker node of a plurality of worker nodes, the first query based on constraints to train a machine learning model, cause transmission of a second query to a second worker node of the plurality of worker nodes, the second query based on the constraints, and cause transmission of a third query to the first worker node based on comparison of a first score from the first worker node to a second score from the second worker node, the third query instructing the first worker node to train the machine learning model.

Example 9 includes the non-transitory computer readable storage medium of example 8, wherein the third query specifies a first quantity of resources to be used by the first worker node to train the machine learning model, and the instructions are to cause the programmable circuitry to cause transmission of a fourth query to the second worker node, the fourth query instructing the second worker node to train the machine learning model using a second quantity of resources less than the first quantity of resources to be used by the first worker node.

Example 10 includes the non-transitory computer readable storage medium of example 9, wherein the instructions are to cause the programmable circuitry to obtain first weights for the machine learning model from the first worker node, obtain second weights for the machine learning model from the second worker node, and update the machine learning model based on an aggregation of the first weights and the second weights.

Example 11 includes the non-transitory computer readable storage medium of example 8, wherein the first score is based on a quantity of data stored by the first worker node that is associated with a category identified in the constraints.

Example 12 includes the non-transitory computer readable storage medium of example 8, wherein the instructions are to cause the programmable circuitry to assign a first access policy to first data stored by the first worker node, and assign a second access policy to second data stored by the second worker node, the first access policy to prohibit the second worker node from access to the first data.

Example 13 includes the non-transitory computer readable storage medium of example 8, wherein the constraints include at least one of a target classification accuracy, a training round limit, or a list of worker nodes.

Example 14 includes the non-transitory computer readable storage medium of example 8, wherein the instructions are to cause the programmable circuitry to obtain the constraints via at least one of an application programming interface, a web server, or a container.

Example 15 includes a method comprising transmitting a first query to a first worker node of a plurality of worker nodes, the first query based on constraints to train a machine learning model, transmitting of a second query to a second worker node of the plurality of worker nodes, the second query based on the constraints, comparing a first score from the first worker node to a second score from the second worker node to determine whether to transmit a third query to the first worker node, the third query instructing the first worker node to train the machine learning model, and transmitting the third query to the first worker node.

Example 16 includes the method of example 15, wherein the third query specifies a first quantity of resources to be used by the first worker node to train the machine learning model, and further including transmitting a fourth query to the second worker node, the fourth query instructing the second worker node to train the machine learning model using a second quantity of resources less than the first quantity of resources to be used by the first worker node.

Example 17 includes the method of example 16, further including obtaining first weights for the machine learning model from the first worker node, obtaining second weights for the machine learning model from the second worker node, and updating the machine learning model based on an aggregation of the first weights and the second weights.

Example 18 includes the method of example 15, wherein the first score is based on a quantity of data stored by the first worker node that is associated with a category identified in the constraints.

Example 19 includes the method of example 15, further including assigning a first access policy to first data stored by the first worker node, and assigning a second access policy to second data stored by the second worker node, the first access policy to prohibit the second worker node from access to the first data.

Example 20 includes the method of example 15, wherein the constraints include at least one of a target classification accuracy, a training round limit, or a list of worker nodes.

Example 21 includes the method of example 15, further including obtaining the constraints via at least one of an application programming interface, a web server, or a container.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
interface circuitry;
one or more instructions; and
programmable circuitry to utilize the one or more instructions to:
cause transmission of a first query to a first worker node of a plurality of worker nodes, the first query based on constraints to train a machine learning model;
cause transmission of a second query to a second worker node of the plurality of worker nodes, the second query based on the constraints; and
cause transmission of a third query to the first worker node based on comparison of a first score from the first worker node to a second score from the second worker node, the third query instructing the first worker node to train the machine learning model.

2. The apparatus of claim 1, wherein the third query specifies a first quantity of resources to be used by the first worker node to train the machine learning model, and the programmable circuitry is to cause transmission of a fourth query to the second worker node, the fourth query instructing the second worker node to train the machine learning model using a second quantity of resources less than the first quantity of resources to be used by the first worker node.

3. The apparatus of claim 2, wherein the programmable circuitry is to:
obtain first weights for the machine learning model from the first worker node;
obtain second weights for the machine learning model from the second worker node; and
update the machine learning model based on an aggregation of the first weights and the second weights.

4. The apparatus of claim 1, wherein the first score is based on a quantity of data stored by the first worker node that is associated with a category identified in the constraints.

5. The apparatus of claim 1, wherein the programmable circuitry is to:
assign a first access policy to first data stored by the first worker node; and
assign a second access policy to second data stored by the second worker node, the first access policy to prohibit the second worker node from access to the first data.

6. The apparatus of claim 1, wherein the constraints include at least one of a target classification accuracy, a training round limit, or a list of worker nodes.

7. The apparatus of claim 1, wherein the programmable circuitry is to obtain the constraints via at least one of an application programming interface, a web server, or a container.

8. A non-transitory computer readable storage medium comprising instructions to cause programmable circuitry to at least:
cause transmission of a first query to a first worker node of a plurality of worker nodes, the first query based on constraints to train a machine learning model;
cause transmission of a second query to a second worker node of the plurality of worker nodes, the second query based on the constraints; and
cause transmission of a third query to the first worker node based on comparison of a first score from the first worker node to a second score from the second worker node, the third query instructing the first worker node to train the machine learning model.

9. The non-transitory computer readable storage medium of claim 8, wherein the third query specifies a first quantity of resources to be used by the first worker node to train the machine learning model, and the instructions are to cause the programmable circuitry to cause transmission of a fourth query to the second worker node, the fourth query instructing the second worker node to train the machine learning model using a second quantity of resources less than the first quantity of resources to be used by the first worker node.

10. The non-transitory computer readable storage medium of claim 9, wherein the instructions are to cause the programmable circuitry to:
obtain first weights for the machine learning model from the first worker node;
obtain second weights for the machine learning model from the second worker node; and
update the machine learning model based on an aggregation of the first weights and the second weights.

11. The non-transitory computer readable storage medium of claim 8, wherein the first score is based on a quantity of data stored by the first worker node that is associated with a category identified in the constraints.

12. The non-transitory computer readable storage medium of claim 8, wherein the instructions are to cause the programmable circuitry to:
assign a first access policy to first data stored by the first worker node; and
assign a second access policy to second data stored by the second worker node, the first access policy to prohibit the second worker node from access to the first data.

13. The non-transitory computer readable storage medium of claim 8, wherein the constraints include at least one of a target classification accuracy, a training round limit, or a list of worker nodes.

14. The non-transitory computer readable storage medium of claim 8, wherein the instructions are to cause the programmable circuitry to obtain the constraints via at least one of an application programming interface, a web server, or a container.

15. A method comprising:
transmitting a first query to a first worker node of a plurality of worker nodes, the first query based on constraints to train a machine learning model;
transmitting of a second query to a second worker node of the plurality of worker nodes, the second query based on the constraints;
comparing a first score from the first worker node to a second score from the second worker node to determine whether to transmit a third query to the first worker node, the third query instructing the first worker node to train the machine learning model; and
transmitting the third query to the first worker node.

16. The method of claim 15, wherein the third query specifies a first quantity of resources to be used by the first worker node to train the machine learning model, and further including transmitting a fourth query to the second worker node, the fourth query instructing the second worker node to train the machine learning model using a second quantity of resources less than the first quantity of resources to be used by the first worker node.

17. The method of claim 16, further including:
obtaining first weights for the machine learning model from the first worker node;
obtaining second weights for the machine learning model from the second worker node; and
updating the machine learning model based on an aggregation of the first weights and the second weights.

18. The method of claim 15, wherein the first score is based on a quantity of data stored by the first worker node that is associated with a category identified in the constraints.

19. The method of claim 15, further including:
assigning a first access policy to first data stored by the first worker node; and
assigning a second access policy to second data stored by the second worker node, the first access policy to prohibit the second worker node from access to the first data.

20. The method of claim 15, wherein the constraints include at least one of a target classification accuracy, a training round limit, or a list of worker nodes.

21. (canceled)
